(19) United States
(12) Patent Application Publication
(10) Pub. No.: US 2012/0297228 A1
(43) Pub. Date: Nov. 22, 2012

(54) DATA RECORDER FOR HARSH ENVIRONMENTS

(75) Inventors: Justin M. Graves, Middletown, OH (US); Chad A. Ruttencutter, Springboro, OH (US); Barry T. Neyer, Cincinnati, OH (US)

(73) Assignee: EXCELITAS TECHNOLOGIES SENSONRS, INC., Miamisburg, OH (US)

(21) Appl. No.: 13/112,946

(22) Filed: May 20, 2011

(51) Int. Cl. G06F 1/28; G06F 12/00

(52) U.S. Cl. 713/340; 711/154; 711/E12.001

(57) ABSTRACT

A data recorder configured to idle in a power-saving mode until an input trigger signal is received by the data recorder. After the trigger signal is received, the data recorder samples input data sequentially at successive time intervals, and may record the sampled input data into non-volatile memory. The data recorder samples but does not record data from an input if the data have not changed by a predetermined threshold since data for the input was last recorded. The data recorder monitors and identifies an imminent failure in its power supply, and powers down into a power-saving mode after completing the recording of any sampled but incompletely recorded data, as necessary. The data recorder is configured to recover from a brownout and resume sampling and/or recording data. The data recorder is also configured to recover from a blackout and resume sampling and/or recording data.

### BACKGROUND

1. Field

The present disclosure relates generally to the field of data recording devices, and more specifically to data recorders designed to operate in harsh environments.

2. Description of Related Art

A “data recorder” may generally refer to an electronic device that may be configured to record data received at an input of the device over time. A data recorder may record information continuously, or may record information in relationship to a specific event. A continuous data recorder generally operates under the principle that data collection should occur continuously. For example, a data recorder that is used to record weather information (e.g., temperature) at a weather station may be a continuous recorder designed to operate 24×7.

In contrast, an event data recorder generally operates under the principle that data collection should occur around a specific event. For example, a data recorder that is used to record information surrounding the deployment of airbags during automotive crash testing may be referred to as an event recorder. An event data recorder may be configured to idle until the moments immediately preceding an event of interest. As the event approaches, a trigger signal may be given to the event data recorder so that the event data recorder may begin to record. An event data recorder may also be configured to continue recording after the event, such that as much information as possible about the event may be recorded.

A skilled person would appreciate, however, that the distinction between continuous and event-driven data recorders may be blurry: a given data recorder may record some information continuously, and record more information surrounding an event of interest. In addition, a data recorder may also be configured to record (or to not record) based on a number of other considerations such as, e.g., the amount of available storage memory.

Conventional data recorders may not be adapted for use in harsh environments. For example, a conventional data recorder may be too large to fit inside the parent device that is to be monitored. As a result, a conventional data recorder may be placed external to the parent device, and may be connected to the parent device using wires and connectors that are not protected by the housing of the parent device. In practice, external interconnecting wires are unreliable in high shock and vibration environments. A conventional data recorder so configured may fail to record information if the wires and/or connectors became unconnected and/or damaged during the operation of the parent device.

A conventional data recorder may also cease to record data abruptly upon power loss. For instance, a conventional data recorder may fail to record during momentary drops in input power because the conventional data recorder may not include any reserve power storage. An abrupt shutdown may also result in corruption of the data that have been recorded. For instance, a conventional data recorder may not be able to store the last bits of data completely into memory after a power loss. When the stored information is later retrieved from the data recorder, it may be difficult to determine if the stored information is in fact complete, or is incomplete and therefore corrupt.

A conventional data recorder may also fail to resume recording data after power is restored, thereby resulting in a lack of data being recorded. Since temporary power losses are common during the use of a data recorder in a harsh environment, a conventional data recorder that experiences a temporary power loss may become unable to record valuable information, even after input power is restored.

A conventional data recorder may also fail to evaluate an input signal in order to determine if the input signal should be recorded. For example, a conventional data recorder that is used in a harsh environment may experience constant electrical noises that are related to background vibration and shock and are not representative of useful data. A conventional data recorder may indiscriminately record the background electrical noise into memory thereby consuming valuable memory space.

### BRIEF SUMMARY

In an exemplary embodiment, a data recorder may include a processor and a non-volatile memory. The data recorder may be configured to receive input power from an input source, to receive data from one or more inputs, and to store the received data into the non-volatile memory. The processor may be configured to monitor the input power and may determine whether the monitored input power drops below a predetermined level. If the monitored input power drops below the predetermined level, the processor may be configured to complete any incomplete storing of the received data into the non-volatile memory.

The processor may be configured to power down into a power-saving mode in which the processor may stop processing input data so that the data recorder may consume less input power. In the power-saving mode, the processor may be configured to monitor the input power to determine whether the monitored input power returns to at least a predetermined level. If the monitored input power returns to at least the predetermined level, the processor may be configured to resume receiving data and to resume storing the received data into the non-volatile memory.

The data recorder may be configured to receive input power and to determine whether a non-volatile memory contains stored data. If the non-volatile memory contains stored data, the processor may be configured to begin to receive data from one or more inputs and to store the received data into the non-volatile memory. If the non-volatile memory does not contain stored data, the processor may be configured to monitor a trigger input, and begin receiving data from the inputs and storing the received data into non-volatile memory after the trigger input is triggered.

The data recorder may be configured to receive a plurality of inputs connected to a processor, the processor may operate to sequentially receive sets of inputs at successive time intervals. The processor may be configured to compare the most recently received set of inputs to the previously received set of inputs and storing the most recently received inputs only when at least one of the recently received inputs differs from the corresponding previously received input.

The plurality of inputs may include an input configured to receive analog data and an input configured to receive digital data and the processor may operate to store the most recently received inputs if at least one of the digital inputs is different from the corresponding digital input in the previously received set of inputs. If the digital inputs in the most recently received set of inputs are the same as the digital data in the previously received set of inputs, then the processor may be configured to store the most recently received inputs only if at least one of the analog inputs in the most recently received inputs is different from the corresponding previously received analog input by a predetermined amount.

### DESCRIPTION OF THE FIGURES

FIG. 1 is a block diagram illustrating the components of an exemplary data recorder.

FIG. 2 is a flowchart depicting an exemplary process for recording data.

FIG. 3 is a flowchart depicting an exemplary process for determining whether to sample input data.

FIG. 4 is a flowchart depicting an exemplary process for sampling and storing input data.

FIG. 5 is a flowchart depicting an exemplary process for determining whether to store input data.

FIG. 6 is a flowchart depicting an exemplary process representing a power-saving state.

FIG. 7 is a flowchart depicting an exemplary process for recording data after a brownout.

### DETAILED DESCRIPTION

The following description sets forth exemplary methods, parameters and the like. It should be recognized, however, that such description is not intended as a limitation on the scope of the present disclosure but is instead provided as a description of exemplary embodiments.

The embodiments described herein include a data recorder configured for recording data in a variety of environments, including harsh environments that may cause the data recorder to experience a temporarily loss and/or surge of input signal and/or input power. As used herein, a harsh environment may refer to conditions of extreme temperatures, high levels of acceleration and/or deceleration, shock, vibration and the like. Examples of harsh environments may include the environments present in automotive crash testing, rocket propulsion, the operation of projectiles designed to penetrate physical structures, demolition, and the like. It should be understood by one of ordinary skill in the art that a data recorder capable of functioning in a harsh environment may also be capable of functioning in a non-harsh environment. As such, the embodiments and examples described herein are not intended to limit the applications of the present technology.

In an exemplary embodiment, the present technology may include a combination of hardware components and processor (e.g., a microcontroller unit, hereafter MCU) logic configured to record input data in a harsh environment. During normal operation, a data recorder may be configured to idle in a power-saving (e.g., standby) mode, until a trigger signal is received. When a trigger signal is received, the data recorder may begin to sample its input(s) for information and to record the information into non-volatile memory for later retrieval. A data recorder may include logic to screen out background electrical noise (e.g., due to vibration and/or shock) such that the background electrical noise may not be recorded. Further, a data recorder may include MCU logic to suspend the recording process and enter a power-saving mode if a loss of input power is imminent. A data recorder may also include MCU logic to resume the recording process when input power is restored. The hardware and MCU logic components that may be included in a data recorder are discussed below, in turn.

### 1. Hardware

In one embodiment, a data recorder may include a number of hardware elements assembled onto a printed wire board (PWB). A PWB provides a mechanical structure on which various hardware elements constituting a data recorder may be connected into an electrical circuit. Hardware elements may be placed onto the PWB in a high density layout in order to minimize the footprint of the data recorder. A physically compact data recorder may be placed inside the existing housing of a device that is to be monitored by the data recorder (e.g., a parent device), even if the housing of the parent device may not have been designed to house a data recorder.

The placement of a data recorder into a parent device's housing may provide advantages. For example, a parent device's housing may be designed to withstand the operating environment of the parent device, thus the placement may improve the survivability of the data recorder during use. The placement may also alleviate the need for an external housing and the impacts that an external housing may have on the performance of the parent device. Moreover, the placement may reduce the need for interconnecting wires between the data recorder and the parent device, thereby reducing the chance that an interconnecting wire may be damaged during use.

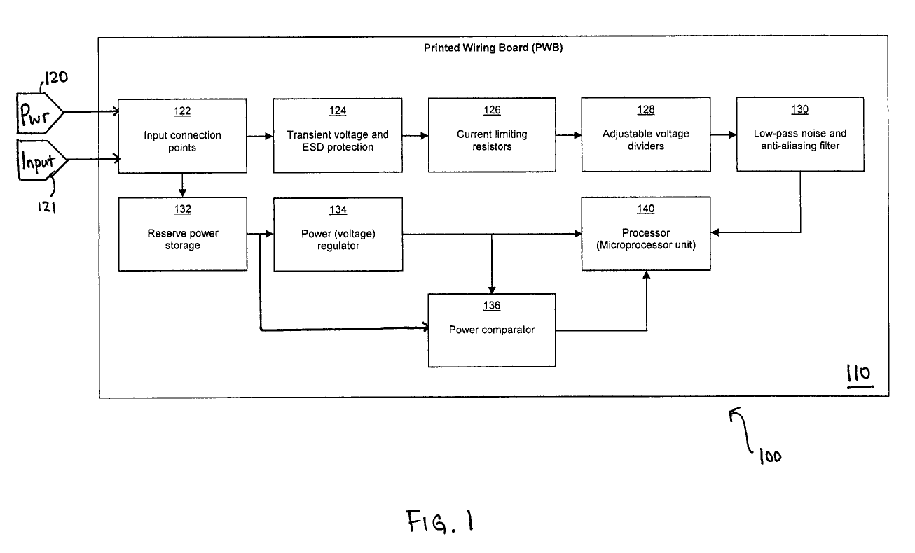

FIG. 1 is a block diagram illustrating the components of exemplary data recorder 100. Data recorder 100 may include PWB 110 which provides the mechanical structure on which the components of data recorder 100 may be fastened and connected electrically. Data recorder 100 may include connection points 122 for the connecting of input power 120 and input signals 121 to data recorder 100. Input signals 121 may include a number of individual inputs that carry digital and/or analog signals. Input connection points 122 may be pins arranged into a male and/or female electrical header. Connection points 122 may also be openings in PWB 110 which may couple directly with the leads on a pitch ribbon cable and/or discrete wires.

Input connection points 122 may be connected to a transient voltage suppressor (TVS) 124. TVS 124 may suppress excess voltage and electrical static discharges (ESD) received at connection points 122 so that other components downstream from TVS 124 may be protected from voltage spikes and ESD, to the degree made possible by TVS 124. Further, TVS 124 may be connected to current limiting resistors 126. Current limit resistors 126 may limit the electrical current passing through each input of input signals 121. Components downstream from current limiting resistors 126 may be protected from current spikes in an input signal, to the degree made possible by current limiting resistors 126. Current limiting resistors 126 may include one or more resistors. When current limiting resistors 126 include more than one resistor, the resistors may be connected in series.

Current limiting resistors 126 may be connected to adjustable voltage dividers 128. Adjustable voltage dividers 128 may divide the voltage potential of an input signal by an adjustable factor, and may allow data recorder 100 to be used with upstream input sources that may produce a higher output than the voltage potential accepted by data recorder 100. For example, in one embodiment, microcontroller unit (MCU) 140 of data recorder 100 may accept inputs ranging from 0V to +3.3V. The use of an adjustable voltage divider, configured to divide an incoming voltage by half, may allow MCU 140 to be connected with an upstream component that may have a voltage potential of 0V to +6.6V.

Data recorder 100 may also include low-pass filter 130. Low-pass filter 130 may reduce high frequency electrical noise contained within input 121. Data recorder 100 may also include reserve power storage 132. Reserve power storage 132 may include a battery, a capacitor, and the like. Reserve power storage 132 may be initially charged by input power 120. Once charged, reserve power storage 132 may provide power to data recorder 100 in the event that input power 120 becomes non-functional. Reserve power storage 132 may also supplement input power 120 during momentary drops in input power 120.

Input power 120 and reserve power storage 132 may be connected to a buck, a boost, or buck-boost regulator 134. Buck-boost regulator 134 may use input power 120 and reserve power storage 132 to produce a substantially fixed output voltage (e.g., +3.3V). One of ordinary skill in the art would appreciate that buck-boost regulator 134 may produce a substantially fixed output voltage even if the input voltage to buck-boost regulator 134 is above, or below, the desired output voltage (e.g., +3.3V). For example, power input 120 and reserve power storage 132 may have voltage potentials of +5V. Here, buck-boost regulator 134 may “buck” the input voltage (+5V) and produce a lower output voltage (+3.3V). As another example, during use of data recorder 100, power input 120 may become non-functional, and reserve power storage 132 may become depleted and unable to provide an input voltage of +3.3V to buck-boost regulator 134. Here, buck-boost regulator 134 may “boost” the input voltage provided by reserve power input 134 and produce a higher output voltage (+3.3V)

In one embodiment, buck-boost regulator 134 may be configured to produce an output voltage of +3.3V using a minimum input voltage of +2.1V. The input voltage of 2.1V may be received by buck-boost regulator 134 from any combination of input power 120 and/or reserve power storage 132.

Referring again to FIG. 1, data recorder 100 may include a power comparator 136, also called a voltage comparator. Power comparator 136 may provide a digital signal to a microcontroller unit (MCU) 140 that indicates the proper operation of buck-boost regulator 134. Power comparator 136 may be a standalone component in some embodiments, or may be packaged as part of buck-boost regulator 134 in other embodiments.

For example, in an embodiment discussed above, power comparator 136 is incorporated into buck-boost regulator 134. Buck-boost regulator 134 may maintain an output of +3.3V from a minimum input voltage of +2.1V. Thus, power comparator 136 may indicate that buck-boost regulator 134 is able to provide stable power to MCU 140 as long as the input power supply (e.g., input power 120 and/or reserve power storage 132) to buck-boost regulator 134 reaches a minimum of +2.1V. When the input power supply to buck-boost regulator 134 drops below +2.1V, power comparator 136 may indicate that buck-boost regulator 134 is unable to maintain stable power to MCU 140, since the input power supply to buck-boost regulator 134 has dropped below the minimum voltage that may be required by buck-boost regulator 134 to maintain an output voltage of +3.3V.

In addition, power comparator 136 may indicate that buck-boost regulator 134 is unable to maintain stable power to data recorder 100 if the output of buck-boost regulator 134 has dropped below a certain voltage (e.g., +3.3V). It may be possible for the output of buck-boost regulator 134 to drop below +3.3V, e.g., if the output of buck-boost regulator 134 becomes grounded and/or shorted. It should be noted that power comparator 136 may monitor the input power supply to buck-boost regulator 134 and/or the output of buck-boost regulator 134, either alone or in combination.

Power comparator 136 may indicate that buck-boost regulator 134 is able to maintain a constant output potential by producing a high value (e.g., “1”) in its digital signal. Similarly, power comparator 136 may indicate that buck-boost regulator 134 is unable to maintain constant output potential by producing a low value (e.g., “0”) in its digital signal. The digital signal of power comparator 136 may be significant to data recorder 100 in at least two ways. First, as discussed above, the static value (e.g., “1” or “0”) of the digital signal may indicate whether buck-boost regulator 134 is currently able to maintain output power to data recorder 100. Second, a change in the value of the digital signal, such as a change from a high value to a low value (i.e., a falling edge), may indicate that buck-boost regulator 134 has recently become unable to maintain sufficient output power to data recorder 100. Similarly, a change from a low value to a high value (i.e., a rising edge) may indicate that buck-boost regulator 134 has recently become able to produce sufficient output power.

Thus, data recorder 100 may monitor the digital signal of power comparator 136 (for both static values and transient changes) in order to determine whether data recorder 100 may initiate specific actions in response to a failure in the input power supply to data recorder 100. Similarly, data recorder 100 may also monitor the digital signal of power comparator 136 to determine whether data recorder 100 may resume the sampling and recording of data into non-volatile memory after the input power supply is restored.

More specifically, data recorder 100 may monitor the digital signal of power comparator 136 for both static values and transient changes to produce synergistic effects. In the context of the present technology, input power 120 may fail momentarily as a result of interactions between the parent device and a harsh environment, thereby causing a falling edge in the digital signal of power comparator 136. As discussed above, the falling edge may cause data recorder 100 to initiate power-saving actions. However, the input power failure may be momentary, and may resume quickly. That is, input power 120 may resume after the initiation of power-saving actions, but before the completion of the power-saving actions. Similarly, input power 120 may resume after the initiation of power-saving actions, but before data recorder 100 becomes able to monitor and react to a rising edge in the digital signal of power comparator 136. In either situation, it may be useful for data recorder 100 to monitor the static value of the digital output of power comparator 136 as data recorder 100 performs its power-saving actions, in order to determine if the power-saving actions may continue, or if the power-saving actions may be averted because input power has become stable. Thus, in certain portions of the MCU logic to be discussed below, data recorder 100 may monitor the digital output of power comparator 136 for both static values and transient changes in value.

Finally, data recorder 100 may include MCU 140. MCU 140 may perform the sampling of input signals and the storing of sampled input signals. MCU 140 may receive input signal 121 after input signal 121 passes through low pass filter 130. MCU 140 may also receive the digital signal from power comparator 136 as an input signal. Further, MCU 140 may receive input power from the input power supply (e.g., input power 120 and/or reserve power storage 132) through voltage regulator 134. MCU 140 may include internal non-volatile memory for the storage of sampled input signals; however, non-volatile memory external to MCU 140 may also be used for the storage of sampled input signals. As used here, and consistent with the normal usage of the term, non-volatile memory refers to computer memory that can retain stored information even when the non-volatile memory is not powered.

It should be noted that, in some embodiments, data recorder 100 may include volatile memory used for buffering data that have been sampled by data recorder 100. Volatile memory may store information more quickly than non-volatile memory because volatile memory may have shorter memory-write cycles. Input signals sampled by data recorder 100 may be stored in volatile memory first, and be copied or transferred to non-volatile memory later. Since data may be written more quickly to volatile memory, the sampling rate of data recorder 100 may be increased if sampled data are first stored in volatile memory. In other words, data recorder 100 may sample input signals at a higher sampling frequency. Although the use of volatile memory for this purpose of buffering is possible, the use of volatile memory for buffering is not mandatory. The sampling frequency of data recorder 100 may be adjusted in light of the speed at which the non-volatile memory of data recorder 100 may store data. For example, in one embodiment, data recorder 100 may be configured with non-volatile memory and may sample incoming input signals at a frequency of 593 Hz.

In one embodiment, MCU 140 may be a 16-bit field programmable microcontroller marketed under the designation of MSP430™ by Texas Instruments, Inc. However, one of ordinary skill in the art would appreciate that other field programmable devices capable of receiving input signals, processing interrupt signals, and generating output signals (and/or storing outputs into on-board memory) may be used. For example, a number of field programmable arrays marketed by Altera Corp. may also be used. In addition, an application specific integrated circuit (ASIC) embodying the MCU logic described below may be produced for use with data recorder 100.

### 2. MCU Logic

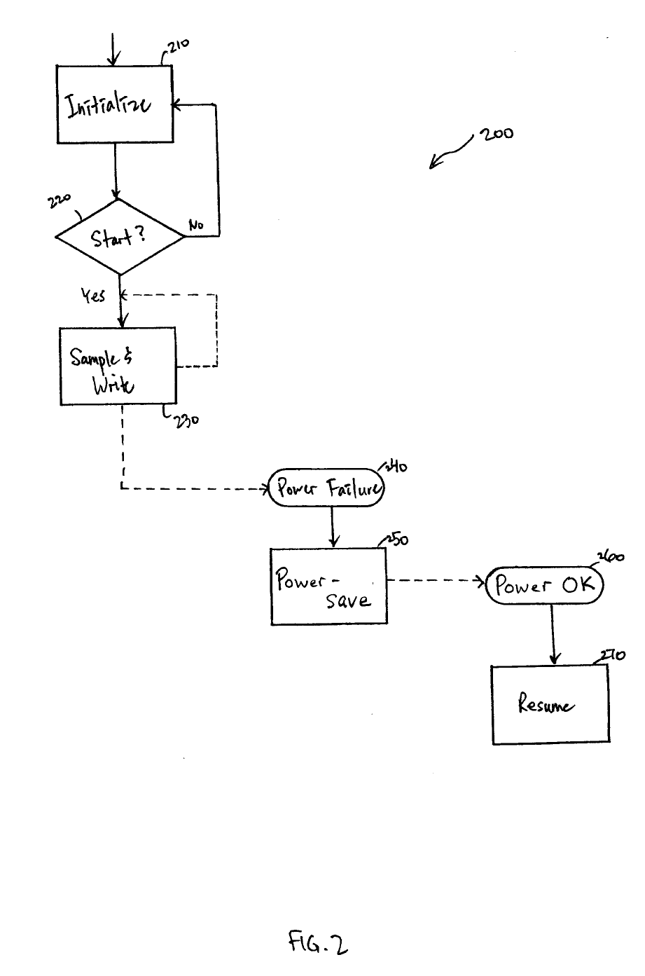

FIG. 2 is a flowchart depicting an exemplary process 200 for recording data. MCU 140 (FIG. 1) may include MCU logic that enables data recorder 100 to carry out process 200. Process 200 is now described with continued reference to the components of data recorder 100 as described in FIG. 1 and above.

At block 210, data recorder 100 may receive input power from an input power supply (e.g., input power 120 and/or reserve power storage 132 shown in FIG. 1). The received input power may cause MCU 140 (FIG. 1) of data recorder 100 to initialize. During initialization, MCU 140 may enable certain MCU input/output functionalities. For example, MCU 140 may enable its serial communication capabilities such that data recorder 100 may become responsive to, e.g., an external data reader that is configured to retrieve data from data recorder 100. MCU 140 may also enable a system clock. In addition, MCU 140 may perform other initialization procedures that would be well known to one of ordinary skill in the art, such as the configuration of input registers and the like.

At decision 220, data recorder 100 may determine whether to remain idle or to begin sampling input data. The determination in decision 220 may depend on factors such as the status of a trigger signal, and/or whether data recorder 100 contains data that had been previously recorded. Data recorder 100 may continue to idle until a decision is made to proceed with the sampling of input data. Data recorder 100, in its idle state, may consume less power from the input power supply because MCU 140 may not be sampling and/or recording data. Hence, data recorder 100 may be referred to as being in a power-save mode when data recorder 100 remains idle.

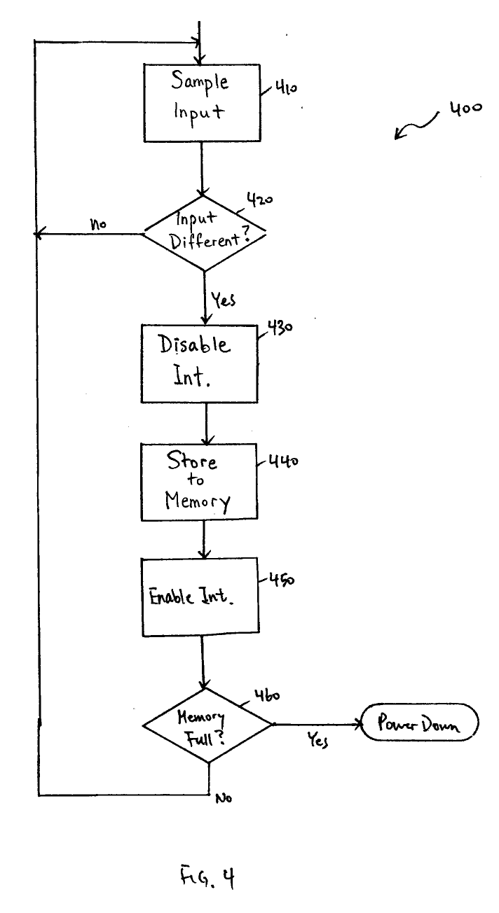

During normal operation, data recorder 100 may remain idle at decision 220 until a trigger signal is provided to data recorder 100. The trigger signal may be a digital signal provided to data recorder 100 by a parent device when an event of interest is about to occur. For example, when data recorder 100 is used with a projectile that is designed to penetrate a target structure, the projectile may provide data recorder 100 a digital high signal (e.g., “1”) at some time during the operation of the projectile that is prior to impact with the target structure. Once data recorder 100 receives the trigger signal, MCU 140 may proceed to block 230, where input signals to data recorder 100 may be processed. Decision 220 will be discussed in additional detail with respect to FIG. 4, below.

At block 230, data recorder 100 may begin to process data by sampling input signals 121 at a predetermined frequency. Specifically, MCU 140 (FIG. 1) may enable a data sampling timer, which may determine a frequency at which data recorder 100 may sample input signals 121 for input data. After data recorder 100 samples a set of input signals, data recorder 100 may store the sampled input signals in non-volatile memory.

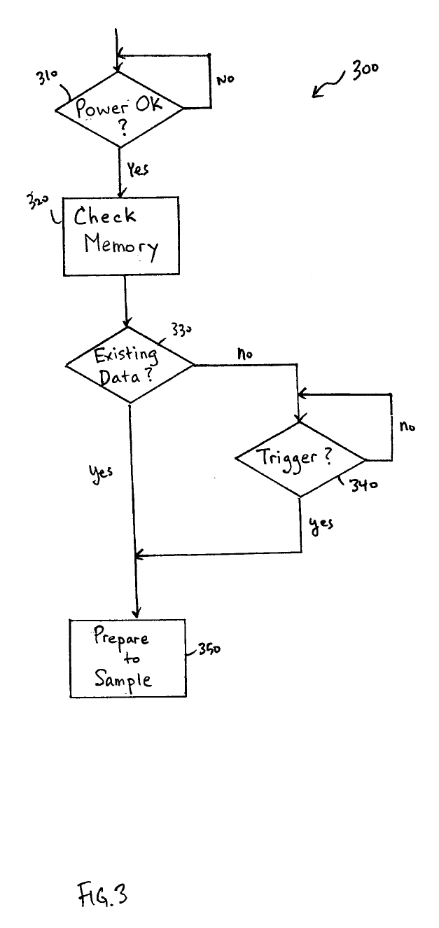

In some embodiments, during normal operation at block 230, data recorder 100 may decide whether to store a set of sampled input signals into non-volatile memory based on changes between the sampled data and data which have been previously stored. Thus, a set of sampled input signals may not be repeatedly stored into non-volatile memory if the set is unchanged, thereby conserving valuable memory space for later use. Block 230 will be discussed in additional detail with respect to FIG. 3, below.

Block 230, which performs the sampling and storing of input data, may repeat at the predetermined frequency until the non-volatile memory of data recorder 100 becomes full, or until data recorder 100 experiences an input power supply failure. An input power supply failure may occur when buck-boost regulator 134 of data recorder 100 becomes unable to maintain output power to MCU 140. As discussed above with respect to FIG. 1, data recorder 100 may include power comparator 136 that monitors buck-boost regulator 134. Power comparator 136 may signal MCU 140 if buck-boost regulator 134 becomes unable to maintain output power to power MCU 140.

In one embodiment, power comparator 134 may signal MCU 140 of data recorder 100 by changing the digital signal of power comparator 134 from a high signal (e.g., “1”) to a low signal (e.g., “0”), or vice versa. MCU 140 may process the change in the signal from power comparator 136 (e.g., a rising or falling edge) as an interrupt signal. One of ordinary skill in the art would appreciate that an interrupt signal may cause a digital processor, such as MCU 140, to suspend the execution of a current branch of MCU logic. Instead, the digital processor may begin executing an alternate branch of logic that may correspond to the interrupt. Upon completion of the alternate branch of logic corresponding to the interrupt, the digital processor may resume the execution of the suspended MCU logic. For example, MCU 140 may interpret a falling edge in the signal of power comparator 136 as an interrupt to execute instructions for placing data recorder 100 into a power-saving mode. In other words, block 230 may repeatedly sample and store certain data into data recorder 100 at the predetermined frequency until, e.g., MCU 140 receives a change in the signal from power comparator 134.

Referring again to FIG. 2, when MCU 140 (FIG. 1) receives a falling edge in the signal from power comparator 136 (FIG. 1), MCU 140 may interpret the falling edge signal at block 240. At block 240, MCU 140 may interpret the falling edge signal as an interrupt signal instructing data recorder 100 to proceed to block 250. Thus, MCU 140 may suspend the MCU logic associated with block 230, and may begin to execute alternate MCU logic associated with block 250. At block 250, an alternate branch of MCU logic may be executed to place data recorder 100 into a power-saving mode in which data recorder 100 may not sample and/or may not record data. Further, at block 250, MCU 140 may suspend the data sampling timer to further reduce input power usage.

Data recorder 100 may, however, continue to monitor the output of power comparator 136 for changes at block 250. At least two events are possible while data recorder 100 remains in block 250. First, the input power supply to data recorder 100 may be restored before MCU 140 experiences a total power loss. For example, in some embodiments, data recorder 100 may have sufficient reserve power to bridge a temporarily loss in input power 120 (FIG. 1) and may maintain MCU 140 in power-saving mode (e.g., at block 250) for long enough to outlast a momentary input power supply failure. Second, the input power supply to data recorder 100 may not be restored, and MCU 140, along with the other components of data recorder 100, may experience a total power loss.

If the input power supply to data recorder 100 stabilizes before MCU 140 experiences a total power loss, data recorder 100 may resume sampling and/or recording data. When the input power supply stabilizes, power comparator 136 may signal MCU 140 with a rising edge in its output to MCU 140, and MCU 140 may interpret the rising edge signal as an interrupt signal instructing MCU 140 to proceed to block 270. At block 270, MCU 140 may configure data recorder 100 to resume sampling and/or storing data. Specifically, at block 270, MCU 140 may resume the data sampling timer. At the conclusion of block 270, MCU 140 may return to the execution of the MCU logic (e.g., block 230) that was suspended in response to a falling edge signal that was received at block 240.

In the alternative, data recorder 100 may experience a total power loss (e.g., a blackout) while data recorder 100 remains in power-save mode (e.g., at block 250). For example, data recorder 100 may completely deplete its reserve power before input power is restored. In this situation, when data recorder 100 again receives input power, data recorder 100 may re-initialize from block 210.

The ability of data recorder 100 to potentially remain at block 250 until input power is restored may be advantageous for a number of reasons. First, the ability of data recorder 100 to suspend the sampling and recording of data after the completion of block 230 may ensure that any sampled data, which are to be stored to memory, are in fact completely stored to memory before MCU 140 experiences a total power loss. Thus, data recorder 100 may prevent data corruption due to the storing of partial data blocks. Second, if input power is restored to data recorder 100 before MCU 140 experiences a total power loss (e.g., a brownout), then data recorder 100 may resume the recording of data without having to re-initialize MCU 140 from block 210. The ability to resume recording data without having to re-initialize MCU 140 from block 210 improves the recovery time of data recorder 100. For example, in one embodiment, data recorder 100 may resume sampling and recording of data within 1 ms after a brownout. Third, by suspending the sampling and writing of data at block 250, data recorder 100 may reduce its parasitic effects on the parent device to which data recorder 100 is connected.

FIG. 3 depicts an exemplary process 300 that, in one embodiment, may be implemented in MCU 140 (FIG. 1) for carrying out decision 220 of FIG. 2, in which data recorder 100 may determine whether to remain idle or to begin sampling input data.

Referring to FIG. 3, at block 310, MCU 140 may determine whether the input power supply to data recorder 100 is sufficient to provide stable input power to MCU 140. The determination may be made by reading the static value of the output of power comparator 136 (FIG. 1). A static high value in the output indicates that the input power supply is able to provide stable input power to MCU 140.

At block 320, MCU 140 may determine whether data recorder 100 has previously stored contents into its non-volatile memory, and if so, data recorder 100 may identify the next available location in the non-volatile memory for storing additional data. In one embodiment, the non-volatile memory may be searched using a modified binary search algorithm that is based on the sequential addresses of blocks of the non-volatile memory.

At decision 330, MCU 140 may proceed to block 340 if the non-volatile memory of data recorder 100 does not contain previously stored contents. As discussed above, during normal operation, data recorder 100 may idle in a power-saving mode, until a trigger signal is received. Thus, at block 340, MCU 140 may wait for the input of a trigger signal before proceeding to block 350. MCU 140 may be not sampling and/or storing data at block 340, may be not monitoring the digital output of power comparator 136 (FIG. 1) for transient changes. Thus, the power consumption of data recorder 100 may be reduced while MCU 140 waits for a trigger signal, thereby reducing the parasitic effects of data recorder 100 on the parent device to which data recorder 100 is attached. MCU 140 proceeds to block 350 when it receives a trigger signal.

Alternatively, at decision 330, MCU 140 may proceed to block 350 if the non-volatile memory of data recorder 100 contains previously stored contents. Based on the existence of previously stored contents, and MCU 140 may proceed under the assumption that MCU 140 has experienced a blackout (e.g., a loss of power) while data recorder 100 was sampling and/or storing data. In this situation, data recorder proceeds immediately to block 350 in order to resume the sampling and/or storing of data.

At block 350, MCU 140 may prepare data recorder 100 for the sampling and storing of data by enabling the data sampling timer, discussed above. The data sampling timer may determine the frequency at which MCU 140 samples input signals 121 (FIG. 1). In one embodiment, MCU 140 may include a field programmable memory register, the contents of which may be used to determine the frequency of the data sampling timer. An end user may thus configure a default data sampling frequency for data recorder 100 by programming the applicable field programmable memory register of MCU 140. Further, at block 350, MCU 140 may begin to monitor the output of power comparator 136 (FIG. 1) for transient changes.

FIG. 4 depicts an exemplary process 400 that, in one embodiment, may be implemented in MCU 140 (FIG. 1) for carrying out process 230 of FIG. 2, in which data recorder 100 may sample and store input data into non-volatile memory.

Referring to FIG. 4, at block 410, MCU 140 may sample input signals 121 (FIG. 1) at the frequency determined by the data sampling timer. A set of sampled input signals may include a combination of inputs representing analog values and/or inputs representing digital values. MCU 140 may convert the amplitude of each analog input signal into a digital representation corresponding to the amplitude. Further, MCU 140 may process each digital input signal in its native digital representation. The digital representation of each sampled input may be stored in temporary memory locations in MCU 140, such as a register, random access memory (RAM), and the like.

In one embodiment, MCU 140 may sample 6 analog input signals and 16 digital signals at each frequency interval. Each analog input signal may be converted into a digital representation spanning 1 byte (e.g., 8 bits) of digital data. The digital representations may be stored in a temporary memory storage location in MCU 140. One of ordinary skill in the art would appreciate that other numbers of analog and digital input signals may also be possible.

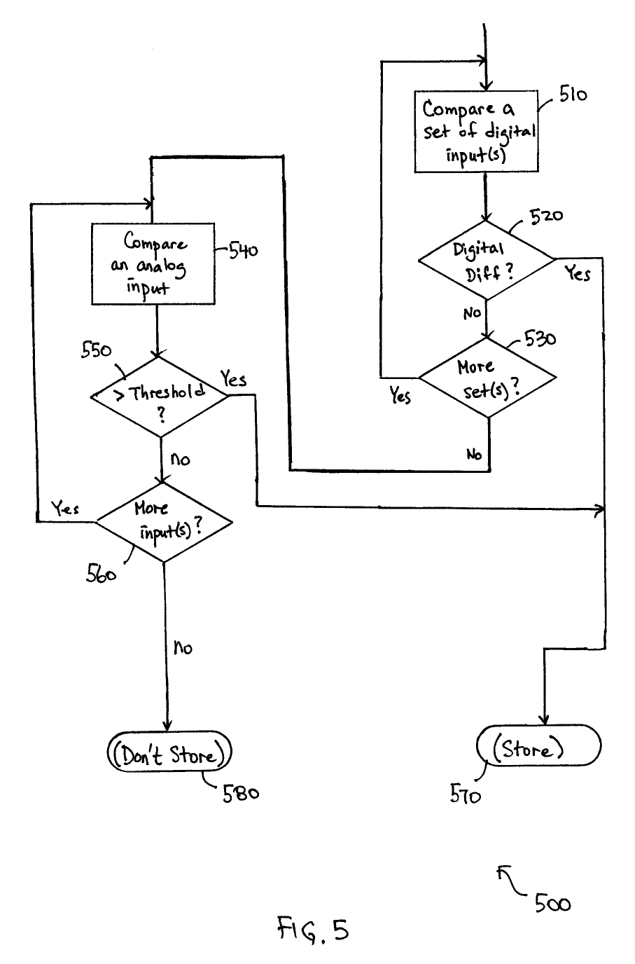

At block 420, MCU 140 determines whether the most recently sampled input signals may be stored into non-volatile memory. Specifically, MCU 140 may compare the digital representations of the most recently sampled input signals (residing in temporary storage) against the representations of the most recently stored input signals (residing in non-volatile memory). MCU 140 may decide to store the digital representations of the most recently sampled input signals into non-volatile memory based on the comparison. Block 420 is discussed in further detail with respect to FIG. 5, below.

If MCU 140 decides to store the digital representations of the most recently sampled input signals into non-volatile memory, MCU 140 may proceed to block 430. If MCU 140 decides to not store the input signals, MCU 140 may repeat block 410, which will obtain an additional sampling of input signals at the next sampling interval as determined by the data sampling timer.

At blocks 430-450, MCU 140 may store the digital representations of the most recently sampled input signals into non-volatile memory. As discussed above, it may be desirable for data recorder 100 to ensure that the most recently sampled input signals are completely, not partially, written to non-volatile memory in order to prevent data corruption due to the partial storing of data blocks into non-volatile memory. However, also as discussed above, in some embodiments, a transient change in the output of power comparator 136 (FIG. 1) may be treated by MCU 140 as an interrupt signal to execute an alternate branch of MCU logic (e.g., to enter a power-saving mode). In light of this, at block 430, MCU 140 may suspend the monitoring of the output of power comparator 136, so that MCU 140 may execute block 440 without potential interruptions by power comparator 136. At block 440, MCU 140 stores the digital representations of the most recently sampled input signals into non-volatile memory. After the completion of block 440, MCU 140 proceeds to block 450, where it may resume the monitoring of power comparator 136. In other words, for the duration of block 440, which includes the storing of data into non-volatile memory, MCU 140 may ignore any interruptions by power comparator 136.

In one embodiment, at block 440, the digital representations of all of the input signals processed by data recorder 100 may be stored into non-volatile memory. In addition, the digital representations may be prepended with a prefix code that indicates the status of a memory block and a timestamp that indicates the time interval at which the input signals were sampled. For example, data recorder 100 may include 6 analog input signals and 16 digital input signals, and MCU 140 may convert and represent the signal of each analog input signal in 1 byte (e.g., 8 bits) of digital data. Further, each digital input signal may be processed by MCU 140 in its native format, e.g., 1 bit of digital data. Thus, the digital representation of all 22 input signals collectively span 8 bytes of digital data. In addition, a timestamp of, e.g., 3 bytes and a prefix code of, e.g., 1 byte may be stored along with the digital representation of input signals. Thus, at block 440, MCU 140 may utilize a total of 12 bytes for each set of input signals that is stored into non-volatile memory.

It should be noted that reserve power storage 132 of data recorder 100 may be sized such that MCU 140 may have sufficient power to store 12 bytes of information completely, even if input power 120 becomes completely unavailable during the performance of block 440. Put another way, since MCU 140 may not reach 440 if power comparator 136 signals an imminent input power failure (e.g., MCU 140 may have been interrupted), it may be assumed that, at the offset of block 440, the input power supply to data recorder 100 is providing at least the minimum voltage (e.g., +2.1V) necessary to maintain stable input power to data recorder 100. Accordingly, in one embodiment, reserve power storage 132 may be sized so that it may, if fully charged, alone provide sufficient power for MCU 140 to completely perform block 440 (e.g., to store 12 bytes of data completely into non-volatile memory). In another embodiment, reserve power storage 132 may be sized to power MCU 140 for the amount of time necessary to store 3 complete sets of sampled input data (e.g., 36 bytes) into non-volatile memory, alone.

At block 460, MCU 140 may determine whether the non-volatile memory is fully used. If the non-volatile memory has remaining capacity, then process 400 may begin again at 410, which may obtain an additional sampling of input signals at the next sampling interval as determined by the data sampling timer. If the non-volatile memory is fully used, then data recorder 100 may stop processing data, and may power down.

FIG. 5 depicts an exemplary process 500 that may be implemented in MCU 140 (FIG. 1) for carrying out process 420 of FIG. 4, in which MCU 140 determines whether to store sampled data into non-volatile memory. As discussed above, during normal operation, a data recorder may experience electrical noises that are related to background vibration and shock. A change in an input signal due to background electrical noise may not represent useful data, and thus may not need to be recorded by data recorder 100, thereby conserving valuable memory space. In one embodiment, MCU 140 may perform process 500 in order to prevent background electrical noise from causing data recorder 100 to record input signals that fluctuate due to background electrical noise but are otherwise unchanged. Specifically, when an analog input signal has changed in amplitude by only a minute amount, the minute change may be presumed to be background electrical noise, and the value of the analog input signal may not be stored again by data recorder 100. Process 500 may allow data recorder 100 to reserve valuable memory space for the recording of actual changes in input signals that are not caused by background electrical noise.

At block 510, MCU 140 may compare the value of a set of the most recently sampled digital input signals (in temporary storage) against the value of a corresponding set of digital inputs that were most recently stored (into non-volatile memory). The size of the set of digital input signals may correspond to a byte size of MCU 140. For example, MCU 140 may compare a set of 8 digital input signals at one time in block 510. A set of 8 input signals, each represented by a single bit, may collectively comprise 1 byte (e.g., 8 bits) of data. A digital comparator of MCU 140 may be configured to compare 1 byte (e.g., 8 bits) of data at a time, and may compare the byte of data representing the digital input signals in a single comparison cycle, thereby reducing the number of clock cycles (e.g., time) needed to perform block 510. It should be noted, however, that sets of other sizes may be compared. For example, in some embodiments, a single digital input signal may be processed by block 510 at a time.

If MCU 140 determines that any of the digital input signals compared at block 510 has changed, MCU 140 may follow decision 520 and may proceed to block 570. Otherwise, MCU 140 may proceed to decision 530. At decision 530, MCU 140 may decide whether there are additional digital input signals to be compared. If there are additional digital input signals to be compared, MCU may return to block 510 for a comparison of the additional digital input signals as an additional set. If there are no additional digital input signals to be compared, MCU 140 may proceed to block 540 where MCU 140 may begin a comparison of the analog input signals to data recorder 100.

At block 540, MCU 140 may compare the digital representation of one of the most recently sampled analog input signals (in temporary storage) against the digital representation of the corresponding analog input that was most recently stored (into non-volatile memory). MCU 140 may perform the comparison for a single analog input signal at a time. MCU 140 may subtract the digital representation of a recently sampled analog input signal (in temporary storage) from the digital representation of the corresponding analog input (stored in non-volatile memory). An absolute value of the subtracted difference may be compared against a predetermined threshold to determine whether one or more of the most recently sampled signals may be stored into non-volatile memory.

At decision 550, if the subtracted difference determined in block 540 exceeds the predetermined threshold, MCU 140 may proceed to block 570. Otherwise, MCU 140 may proceed to block 560. In one embodiment, MCU 140 may include a field programmable memory register, the contents of which may indicate a predetermined threshold. An end user may thus configure a default threshold for data recorder 100 by programming the applicable field programmable memory register of MCU 140.

At decision 560, MCU 140 may decide whether there are additional analog input signals to be compared. If there are additional analog input signals to be compared, MCU 140 may return to block 540 for a comparison of an additional analog input signal. If there are no additional analog signals to be compared, MCU 140 may proceed to block 580.

During normal operation in one embodiment, process 500 may cause MCU 140 to store the values of all input signals into non-volatile memory based on a change the value of one (or more) of the input signals. One of ordinary skill in the art would appreciate that, in other embodiments, MCU 140 may selectively identify one or more input signals for storage. For example, process 500 may determine whether to record each input signal individually, by comparing the most recently sampled value for the input signal against the most recently stored value for the same input signal.

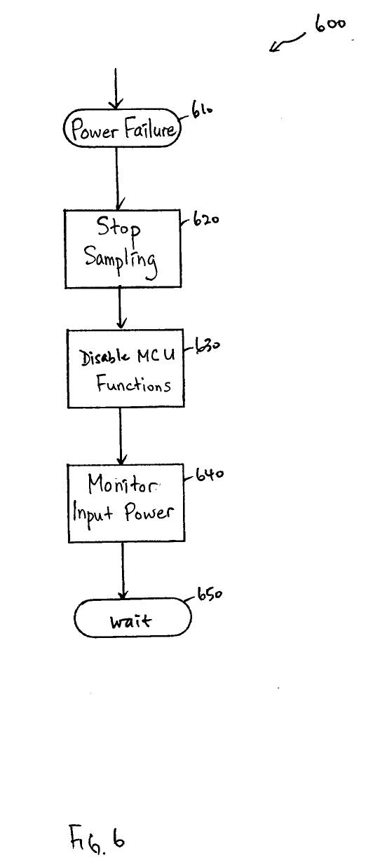

FIG. 6 depicts an exemplary process 600 that, in one embodiment, may be implemented in MCU 140 (FIG. 1) for carrying out process 250 of FIG. 2, in which MCU 140 may enter a power-saving mode such that data recorder 100 may not sample and/or record data into non-volatile memory. MCU 140 may perform process 600 when MCU 140 is enabled to, and in fact does, detect a falling edge in the output of power comparator 136 (FIG. 1).

At block 610, MCU 140 may confirm that the digital signal of power comparator 136 still indicates a low value, in order to ensure that input power to data recorder 100 has not yet been restored. At block 620, MCU 140 may suspend the data sampling timer. In addition, MCU 140 may update certain portions of a memory, a register, and the like, in order to signal that MCU 140 has powered down into a power-saving mode in response to unstable input power. At block 630, MCU 140 may suspend the monitoring of interrupts, such that MCU 140 may become unresponsive to most, if not all, external input. At block 640, MCU 140 may enable an interrupt for the monitoring of a rising edge in the digital signal of power comparator 136. At block 650, MCU 140 may monitor the digital signal of power comparator 136.

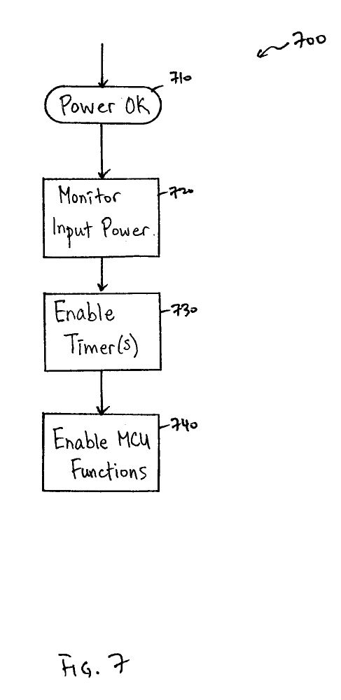

FIG. 7 depicts an exemplary process 700 that, in one embodiment, may be implemented in MCU 140 (FIG. 1) for carrying out process 270 of FIG. 2, in which MCU 140 may exit the power-saving state embodied by process 600, and may resume sampling and/or recording data into non-volatile memory. MCU 140 may perform process 700 when MCU 140 is enabled to, and in fact does, detect a rising edge in the digital signal of power comparator 136 (FIG. 1). As discussed above, in some embodiments, MCU 140 may be enabled to detect a rising edge while data recorder 100 is in a power-saving mode (e.g., process 600). Thus, in some embodiments, MCU 140 may perform process 700 after data recorder 100 experiences an unstable input power supply, but before MCU 140 experiences a power loss. In other words, process 700 may be performed by MCU 140 in order for data recorder 100 to recover from a brownout.

At block 710, MCU 140 may confirm that the digital signal of power comparator 136 still indicates a high value, in order to ensure that input power to data recorder 100 has in fact been restored. At block 720, MCU 140 may enable an interrupt for the monitoring of a falling edge in the digital signal of power comparator 136. At block 730, MCU 140 may re-start the data sampling timer. At block 740, MCU 140 may enable the monitoring of interrupts, such that MCU 140 may become responsive to external input.

The MCU logic embodied in the processes described above may be contained within MCU 140, or as discussed above, other suitable processors. At least some portions of the MCU logic may also be stored (e.g., tangibly embodied) into a computer-readable medium by means of a computer. Specifically, a computer may be used to transfer MCU logic embodied in a computer-readable medium onto a processor such as MCU 140. Similarly, a computer may be used to transfer MCU logic from a processor such as MCU 140 onto a computer-readable medium. Such a computer-readable medium may include a computer program written in an application-specific language (e.g., assembly), and/or a chip-specific design language (e.g., a design application from a processor company).

Although only certain exemplary embodiments have been described in detail above, those skilled in the art will readily appreciate that many modifications are possible in the exemplary embodiments without materially departing from the novel teachings and advantages of this invention. For example, aspects of embodiments disclosed above can be combined in other combinations to form additional embodiments. Accordingly, all such modifications are intended to be included within the scope of this invention.

What is claimed is:

1. A method of recording data received by a processor into a non-volatile memory, comprising:
receiving input power from an input power source;
receiving data from one or more inputs;
storing the received data into the non-volatile memory;
monitoring the input power and determining whether the monitored input power drops below a predetermined level; and
if the monitored input power drops below the predetermined level, completing any incomplete storing of the received data into the non-volatile memory.

2. The method of claim 1, further comprising:
if the monitored input power drops below the predetermined level, stop processing data from the one or more inputs.

3. The method of claim 2, further comprising:
after the monitored input power has fallen below the predetermined level, then determining whether the monitored input power returns to at least the predetermined level; and
if the monitored input power returns to at least the predetermined level, resume receiving data from the one or more inputs and resume storing the received data into the non-volatile memory.

4. The method of claim 1, wherein:
the received input power further includes power from a reserve power source.

5. A method of recording data received by a processor into a non-volatile memory, comprising:
receiving input power from an input power source, wherein the input power is at least at a predetermined level;
determining whether the non-volatile memory contains stored data; and
if the non-volatile memory contains stored data, then begin receiving data from one or more inputs and storing the received data into the non-volatile memory; and
if the non-volatile memory does not contain stored data, then monitoring a trigger input, and after the trigger input is triggered, begin receiving data from the one or more inputs and storing the received data into the non-volatile memory.

6. A method of recording data received by a processor into a non-volatile memory, comprising:
receiving data from a plurality of inputs at a first time, wherein the plurality of inputs includes an input that receives analog data and an input that receives digital data;
receiving additional data from the plurality of inputs at a second time;
determining whether data received at one of the plurality of inputs at the first time is different from the additional data received at the one input of the plurality of inputs at the second time by more than a predetermined amount;
if the determined difference is more than the predetermined amount, then storing all of the additional data received from the plurality of inputs at the second time into the non-volatile memory; and
if the determined difference is not more than the predetermined amount, then not storing the additional data received from the plurality of inputs at the second time into the non-volatile memory.

7. The method of claim 6, wherein:
the one input of the plurality of inputs receives analog data.

8. A method of recording data received by a processor into a non-volatile memory, comprising:
receiving data from an input at a first time, wherein the input receives analog data;
receiving additional data from the input at a second time;
determining whether data received at the input at the first time is different from the additional data received at the input at the second time by more than a predetermined amount;
if the determined difference is more than the predetermined amount, then storing the additional data received from input at the second time into the non-volatile memory; and
if the determined difference is not more than the predetermined amount, then not storing the additional data received from the input at the second time into the non-volatile memory.

9. A data recording device comprising:
a power regulator configured to receive input power from an input power source and to produce output power using the input power source;
a power monitor connected to the power regulator, wherein the power monitor is configured to monitor the input power and to determine whether the monitored input power drops below a predetermined level;
a processor connected to one or more inputs, a non-volatile, and the power monitor, wherein the processor is configured to:
receive data from the one or more inputs;
store the received data into the non-volatile memory;
if the power monitor determines that the monitored input power drops below the predetermined level, complete any incomplete storing of the received data into the non-volatile memory.

10. The data recording device of claim 9, further comprising:
a reserve power source connected to the power regulator; and
wherein the power regulator is further configured to produce the output power using the reserve power source.

11. The data recording device of claim 10, wherein:
the power monitor is further configured to monitor an output power of the power regulator, and to determine whether the monitored output power of the power regulator drops below another predetermined level; and
the processor is further configured to complete any incomplete storing of the received data into the non-volatile memory, if the power monitor determines that the monitored output power of the power regulator drops below the other predetermined level.

12. The data recording device of claim 9, wherein the processor is further configured to:
stop processing data from the one or more inputs, if the monitored input power drops below the predetermined level.

13. The data recording device of claim 9, wherein:
the power monitor is further configured to determine whether the monitored input power returns to at least the predetermined level, after the monitored input power has fallen below the predetermined level and;
the processor is further configured to resume receiving data from the one or more inputs and to resume storing the received data into the non-volatile memory, if the monitored input power returns to at least the predetermined level.

14. A data recording device comprising:
a processor connected to a non-volatile memory; and
a plurality of inputs connected to the processor, the processor operating to sequentially receive sets of inputs at successive time intervals, the processor comparing the most recently received set of inputs to the previously received set of inputs and storing the most recently received inputs only when at least one of the recently received inputs differs from the corresponding previously received input.

15. The data recording device of claim 14, wherein:
the plurality of inputs includes an input configured to receive analog data and an input configured to receive digital data and wherein the processor operates to store the most recently received inputs if at least one of the digital inputs is different from the corresponding digital input in the previously received set of inputs and if the digital inputs in the most recently received set of inputs are the same as the digital data in the previously received set of inputs, then storing the most recently received inputs only if at least one of the analog inputs in the most recently received inputs is different from the corresponding previously received analog input by a predetermined amount.
